(19) United States
(12) Patent Application Publication
(10) Pub. No.: US 2013/0085837 A1
(43) Pub. Date: Apr. 4, 2013

(54) Conversion/Non-Conversion Comparison

(71) Applicant: Matthias Blume, Chicago, IL (US)

(72) Inventor: Matthias Blume, Chicago, IL (US)

(73) Assignee: Google Inc.

(21) Appl. No.: 13/252,165

(22) Filed: Oct. 3, 2011

(51) Int. Cl. G06Q 30/02

(52) U.S. Cl. 705/14.41

(57) ABSTRACT

An apparatus having, a communications interface, a memory to store processor-executable instructions, and a processor communicatively coupled to the at least one communications interface and a memory. Upon execution of the processor-executable instructions, the processor may receive user interaction data, that includes content items and conversion items, where a conversion item is a user action that satisfies a predetermined conversion criteria. The apparatus receives conversion data including conversion path data for a plurality of conversion paths, such that each conversion path includes user interaction data prior to and including a conversion event. The apparatus determines a first and second distribution data that includes a metric that is determined based on one or more events associated with the advertisement. The apparatus compares the first distribution data with the second distribution data to determine the performance data, that indicates whether the advertisement had an affect on the conversion event.

### BACKGROUND

The Internet provides access to a wide variety of content. For instance, images, audio, video, and websites for a myriad of different topics are accessible through the Internet. The accessible content provides an opportunity to place advertisements. Advertisements can be placed within content, such as a website, image or video, or the content can trigger the display of one or more advertisements, such as presenting an advertisement in an advertisement slot.

Advertisers decide which ads are displayed within particular content using various advertising management tools. These tools also allow an advertiser to track the performance of various ads or ad campaigns. The parameters used to determine when to display a particular ad can also be changed using advertising management tools.

The data that is used to generate the performance measures for the advertiser generally includes all data that is available. This data usually includes a combination of data from multiple servers. The amount of the combined data is large enough that performance measures generated from the data can be used to provide an efficient way of understanding the data. Processing of the data to generate useful and accurate performance measures involves a number of obstacles. For instance, if a performance measure is based upon a user's actions over a period of time, the user's actions should be tracked. A cookie can be used to track a user's actions over a period of time. However, if this cookie is removed during the period of time, collection of accurate data tracking the user's actions may be disrupted. The data can contain information regarding user actions that are significant to an advertiser. These actions, which can be any recordable event that meets a predetermined criteria, are called conversions. Identifying other actions that contribute to the occurrence of conversions is valuable. The data, however, contains numerous actions that could be associated with conversions. In addition, the data may also contain information regarding user actions that do not contribute to any recorded conversions. Thus, processing the data to provide accurate and reliable performance measures based on all the available information regarding user actions has a number of challenges.

### SUMMARY

Embodiments of a method for providing data relate to an advertisement include receiving user interaction data with content items and conversion items. A conversion item may be a user action that satisfies a predetermined conversion criteria. The method includes receiving conversion data with conversion path data for a plurality of conversion paths, each conversion path includes user interaction data prior to and including a conversion event. Using a processor a first distribution data is determined, the first distribution data includes a metric that is determined based on one or more events associated with the advertisement, and the one or more events occurred in the plurality of conversion paths. Using a processor a second distribution data is determined, the second distribution data includes a metric that is determined based on one or more events associated with the advertisement, and the one or more events occurred in the user interaction data. A comparison of the first and second distribution data may allow the method to determine the performance data, that indicates whether the advertisement had an affect on the conversion event, based on the comparison of the first distribution data and the second distribution data.

Another embodiment may include at least one non-transitory computer readable storage medium encoded with processor-executable instructions that, when executed by at least one processor, performs a method for providing data related to conversion paths. The method includes receiving user interaction data with content items and conversion items. A conversion item may be a user action that satisfies a predetermined conversion criteria. The method includes receiving conversion data with conversion path data for a plurality of conversion paths, each conversion path includes user interaction data prior to and including a conversion event. Using a processor a first distribution data is determined, the first distribution data includes a metric that is determined based on one or more events associated with the advertisement, and the one or more events occurred in the plurality of conversion paths. Using a processor a second distribution data is determined, the second distribution data includes a metric that is determined based on one or more events associated with the advertisement, and the one or more events occurred in the user interaction data. A comparison of the first and second distribution data may allow the method to determine the performance data, that indicates whether the advertisement had an affect on the conversion event, based on the comparison of the first distribution data and the second distribution data.

An apparatus that includes, a communications interface, a memory to store processor-executable instructions, and a processor communicatively coupled to the at least one communications interface and a memory. Upon execution of the processor-executable instructions, the processor may receive user interaction data, that includes content items and conversion items, where a conversion item is a user action that satisfies a predetermined conversion criteria. The apparatus receives conversion data including conversion path data for a plurality of conversion paths, such that each conversion path includes user interaction data prior to and including a conversion event. The apparatus determines a first distribution data that includes a metric that is determined based on one or more events associated with the advertisement, and the one or more events occurred in the plurality of conversion paths. The apparatus determines a second distribution data that includes a metric that is determined based on one or more events associated with the advertisement, and the one or more events occurred in the user interaction data. The apparatus compares the first distribution data with the second distribution data to determine the performance data based on the comparison of the first distribution data and the second distribution data.

### BRIEF DESCRIPTION OF THE DRAWINGS

Various embodiments taught herein are illustrated by way of example, and not by way of limitation, in the figures of the accompanying drawings, in which:

FIG. 1 is a block diagram of an example environment in which an advertisement management system manages advertising services, according to an illustrative embodiment;

FIG. 2 is a flow diagram of a process for sorting user interaction log data, according to an illustrative embodiment;

FIG. 3 is a block diagram that illustrates user interaction data being updated during a user interaction log data sorting process, according to an illustrative embodiment;

FIGS. 4A-4B are block diagrams that illustrate exemplary conversion and non-conversion paths, according to an illustrative embodiment;

FIG. 5 is a flow diagram that illustrates determining an advertisement's performance based on distribution data comparisons, according to an illustrative embodiment;

FIG. 6 is a flow diagram that illustrates determining one or more user interactions causing non-conversion, according to an illustrative embodiment;

FIG. 7 is a flow diagram that illustrates determining advertisement effect on conversions based on the average path position, according to an illustrative embodiment; and

FIG. 8 is a block diagram illustrating a general architecture for a computer system that may be employed to implement various elements of the system shown in FIG. 1, according to an illustrative embodiment.

It will be recognized that some or all of the figures are schematic representations for purposes of illustration and do not necessarily depict the actual relative sizes or locations of the elements shown. The figures are provided for the purpose of illustrating one or more implementations with the explicit understanding that they will not be used to limit the scope or the meaning of the claims. Like reference numbers and designations in the various drawings indicate like elements.

### DETAILED DESCRIPTION

Following below are more detailed descriptions of various concepts related to, and embodiments of, methods, apparatuses and systems for determining advertisement performance using user interaction and conversion data. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

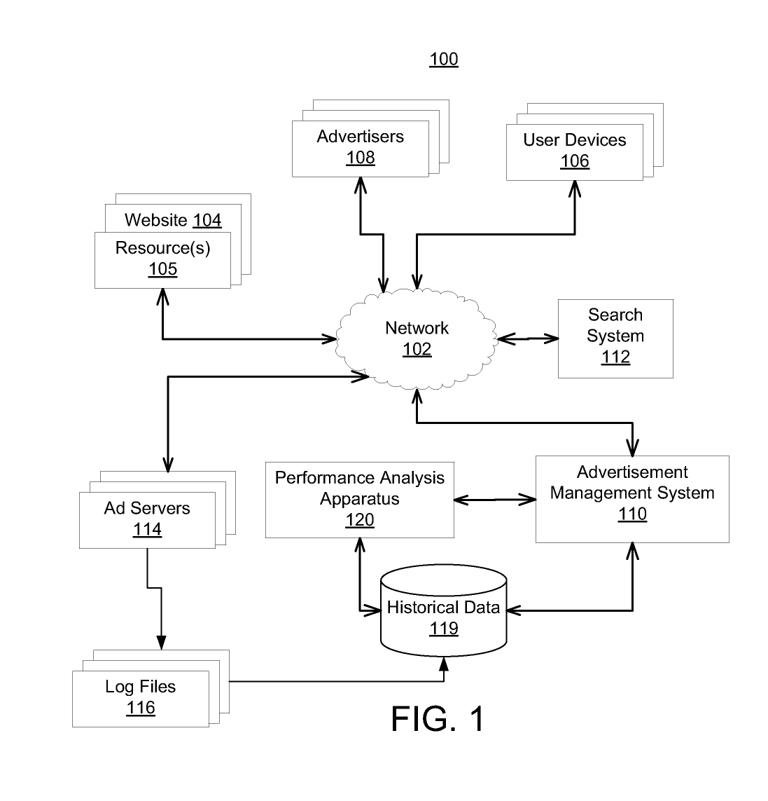

An advertisement management system 110 of FIG. 1 can provide advertisers with information regarding advertisement performance. For example, some advertisements can increase the likelihood of conversions (e.g., product or service purchases), while other advertisements can reduce the likelihood of conversions. To distinguish productive advertisements from advertisements that are counter-productive (e.g., advertisements that drive users away from converting) or avoidable (e.g., advertisements that appear frequently in conversion paths but do not influence the user's decision to convert), the distribution of the advertisements' impressions in conversion paths with either their overall distribution or with their distribution in non-conversion paths is analyzed. For example, if an advertisement appears frequently in conversion paths, but also equally frequently overall, then this advertisement may be a bad performer, since it's appearance in the conversion path does not increase the likelihood of conversion. Similarly, if the advertisement appears more frequently overall than it appears in conversions paths, then it may be suppressing conversions.

In some embodiments, determining when a user plausibly walked away and decided not to convert includes extracting patterns (i.e., sequences of one or more user interactions) derived from conversion paths and locating these patterns in non-conversion paths. A successful advertisement may compel a user to visit the advertiser's website, regardless of whether or not a conversion will occur. The user may choose not to convert because of an unappealing product or website, and not because the advertisement was a poor performer. Accordingly, a successful non-conversion path may end in a visit (e.g., a click leading to the website in question). In some embodiments, relevant clicks are obtained directly from the advertisers. In other embodiments, relevant clicks are inferred from conversion paths. In these embodiments, information regarding clicks that typically precede a given conversion is gathered, and these clicks are used as endpoints of successful non-conversion paths in a similar way as conversions themselves are used as endpoints of conversion paths.

As used throughout this document, user interactions include any presentation of content to a user and any subsequent affirmative actions or non-actions (collectively referred to as “actions” unless otherwise specified) that a user takes in response to presentation of content to the user (e.g., selections of the content following presentation of the content, or non-selection of the content following the presentation of the content). Thus, a user interaction does not necessarily require a selection of the content (or any other affirmative action) by the user.

User interaction measures can include one or more of time lag measures (i.e., measures of time from one or more specified user interactions to a conversion), path length measures (i.e., quantities of user interactions that occurred prior to conversions), user interaction paths (i.e., sequences of user interactions that occurred prior to the conversion), assist interaction measures (i.e., quantities of particular user interactions that occurred prior to the conversion), and assisted conversion measures (i.e., quantities of conversions that were assisted by specified content).

FIG. 1 is a block diagram of an example environment in which an advertisement management system manages advertising services in accordance with an illustrative embodiment. The example environment 100 includes a network 102, such as a local area network (LAN), a wide area network (WAN), the Internet, or a combination thereof. The network 102 connects website 104, user devices 106, advertisers 108, and an advertisement management system 110. The example environment 100 may include many thousands of website 104, user devices 106, and advertisers 108.

A website 104 includes one or more resources 105 associated with a domain name and hosted by one or more servers. An example website is a collection of web pages formatted in hypertext markup language (HTML) that can contain text, images, multimedia content, and programming elements, such as scripts.

A resource 105 is any data that can be provided over the network 102. A resource 105 is identified by a resource address that is associated with the resource 105, such as a uniform resource locator (URL). Resources 105 can include web pages, word processing documents, portable document format (PDF) documents, images, video, programming elements, interactive content, and feed sources, to name only a few. The resources 105 can include content, such as words, phrases, images and sounds, that may include embedded information (such as meta-information in hyperlinks) and/or embedded instructions. Embedded instructions can include code that is executed at a user's device, such as in a web browser. Code can be written in languages such as JavaScript®, ECMAScript® or the like.

User devices 106 is an electronic device that is under the control of a user and is capable of requesting and receiving resources 105 over the network 102. Example user devices 106 include personal computers, mobile communication devices, and other devices that can send and receive data over the network 102. User devices 106 typically include a user application, such as a web browser, to facilitate the sending and receiving of data over the network 102.

User devices 106 can request resources 105 from a website 104. In turn, data representing the resource 105 can be provided to user devices 106 for presentation by user devices 106. The data representing the resource 105 can include data specifying a portion of the resource or a portion of a user display (e.g., a presentation location of a pop-up window or in a slot of a web page) in which advertisements can be presented. These specified portions of the resource 105 or user display are referred to as advertisement slots.

To facilitate searching of the vast number of resources 105 accessible over the network 102, the environment 100 can include a search system 112 that identifies the resources 105 by crawling and indexing the resources 105 provided on the website 104. Data about the resources 105 can be indexed based on the resource 105 with which the data is associated. The indexed and, optionally, cached copies of the resources 105 may be stored, for example, in a search index (not shown).

User devices 106 can submit search queries to the search system 112 over the network 102. In response, the search system 112 accesses the search index to identify resources 105 that are relevant to the search query. In one illustrative embodiment, a search query includes one or more keywords. The search system 112 identifies the resources 105 that are responsive to the query, provides information about the resources 105 in the form of search results and returns the search results to the user devices 106 in search results pages. A search result can include data generated by the search system 112 that identifies a resource 105 that is responsive to a particular search query, and can include a link to the resource 105. An example search result can include a web page title, a snippet of text or a portion of an image extracted from the website 104, a rendering of the resource 105, and the URL of the website 104. Search result pages can also include one or more advertisement slots in which advertisements can be presented.

A search result page can be sent with a request from the search system 112 for the web browser of user devices 106 to set an HTTP (HyperText Transfer Protocol) cookie. A cookie can be identified by, for example, particular user devices 106 and/or a particular web browser. For example, the search system 112 includes a server that replies to the query by sending the search results page in an HTTP response. This HTTP response includes instructions (e.g., a set cookie instruction) that cause the browser to store a cookie for the website hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifier can be anonymized and is not connected with user names. Because HTTP is a stateless protocol, the use of cookies allows an external service, such as the search system 112 or other system, to track particular actions and status of a user over multiple sessions. A user may opt out of tracking user actions, for example, by disabling cookies in the browser's settings.

When a resource 105 or search results are requested by user devices 106 or provided to user devices 106, the advertisement management system 110 receives a request for advertisements to be provided with the resource 105 or search results. The request for advertisements can include characteristics of the advertisement slots that are defined for the requested resource 105 or search results page, and can be provided to the advertisement management system 110. For example, a reference (e.g., URL) to the resource 105 for which the advertisement slot is defined, the size of the advertisement slot, and/or media types that are available for presentation in the advertisement slot can be provided to the advertisement management system 110. Similarly, keywords (i.e., one or more words that are associated with content) associated with a requested resource 105 (“resource keywords”) or a search query for which search results are requested can also be provided to the advertisement management system 110 to facilitate identification of advertisements that are relevant to the resource 105 or search query.

Based on data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries. In some implementations, advertisements having targeting keywords that match the resource keywords, the search query, or portions of the search query are selected as eligible advertisements by the advertisement management system 110.

The advertisement management system 110 selects an eligible advertisement for each advertisement slot of a resource 105 or of a search results page. The resource 105 or search results page is received by user devices 106 for presentation by user devices 106. User interaction data representing user interactions with presented advertisements can be stored in a historical data 119. For example, when an advertisement is presented to the user via ad servers 114, data can be stored in a log file 116. This log file 116, as more fully described below, can be aggregated with other data in the historical data 119. Accordingly, the historical data 119 contains data representing the advertisement impression. For example, the presentation of an advertisement is stored in response to a request for the advertisement that is presented. For example, the advertisement request can include data identifying a particular cookie, such that data identifying the cookie can be stored in association with data that identifies the advertisement(s) that were presented in response to the request. In some implementations, the data can be stored directly to the historical data 119.

Similarly, when a user selects (i.e., clicks) a presented advertisement, data representing the selection of the advertisement can be stored in the log file 116, a cookie, or the historical data 119. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that represent a corresponding user device with which the user interactions were performed. For example, in some implementations, user interaction data can be associated with one or more cookies. Each cookie can include content which specifies an initialization time that indicates a time at which the cookie was initially set on the particular user devices.

The log files 116, or the historical data 119, also store references to advertisements and data representing conditions under which each advertisement was selected for presentation to a user. For example, the historical data 119 can store targeting keywords, bids, and other criteria with which eligible advertisements are selected for presentation. Additionally, the historical data 119 can include data that specifies a number of impressions for each advertisement and the number of impressions for each advertisement can be tracked, for example, using the keywords that caused the advertisement impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

The advertisers 108 can submit, to the advertisement management system 110, campaign parameters (e.g., targeting keywords and corresponding bids) that are used to control distribution of advertisements. The advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements. The campaign performance report can also provide a total cost, a cost-per-click, and other cost measures for the advertisement over a specified period of time. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword hockey can be attributed with 1,000 impressions, 20 clicks, and 5 conversions.

As described above, reports that are provided to a particular content provider can specify performance measures that relate to user interactions with content that occurred prior to a conversion. A conversion occurs when a user performs a specified action, and a conversion path includes a conversion and a set of user interactions occurring prior to the conversion by the user. Any user interaction or user interactions can be deemed a conversion. What constitutes a conversion may vary from case to case and can be determined in a variety of ways. For example, a conversion may occur when a user clicks on an advertisement, is referred to a web page or website, and then consummates a purchase before leaving the web page or website. As another example, a conversion may occur when a user spends more than a given amount of time on a particular website. Data from multiple user interactions can be used to determine the amount of time at the particular website.

Actions that constitute a conversion can be specified by each advertiser. For example, each advertiser can select, as a conversion, one or more measurable/observable user actions such as, for example, downloading a white paper, navigating to at least a given depth of a website, viewing at least a certain number of web pages, spending at least a predetermined amount of time on a website or web page, or registering on a website. Other actions that constitute a conversion can also be used.

To track conversions (and other interactions with an advertiser's website), an advertiser can include, in the advertiser's web pages, embedded instructions that monitor user interactions (e.g., page selections, content item selections, and other interactions) with the advertiser's web pages, and detect a user interaction (or series of user interactions) that constitutes a conversion. In some implementations, when a user accesses a web page, or another resource, from a referring web page (or other resource), the referring web page (or other resource) for that interaction can be identified, for example, by execution of a snippet of code that is referenced by the web page that is being accessed and/or based on a URL that is used to access the web page.

For example, a user can access an advertiser's website by selecting a link presented on a web page, for example, as part of a promotional offer by an affiliate of the advertiser. This link can be associated with a URL that includes data (i.e., text) that uniquely identifies the resource from which the user is navigating. For example, the link http://www.example.com/homepage/% affiliate _identifier % promotion_{—}1 specifies that the user navigated to the example.com web page from a web page of the affiliate that is associated with the affiliate identifier number that is specified in the URL, and that the user was directed to the example.com web page based on a selection of the link that is included in the promotional offer that is associated with promotion_{—}1. The user interaction data for this interaction (i.e., the selection of the link) can be stored in a database and used, as described below, to facilitate performance reporting.

When a conversion is detected for an advertiser, conversion data representing the conversion can be transmitted to a data processing apparatus (“analytics apparatus”) that receives the conversion data, and in turn, stores the conversion data in a data store. This conversion data can be stored in association with one or more cookies for the user device that was used to perform the user interaction, such that user interaction data associated with the cookies can be associated with the conversion and used to generate a performance report for the conversion.

Typically, a conversion is attributed to a targeting keyword when an advertisement that is targeted using the targeted keyword is the last clicked advertisement prior to the conversion. For example, advertiser X may associate the keywords “tennis,” “shoes,” and “Brand-X” with advertisements. In this example, assume that a user submits a first search query for “tennis,” the user is presented a search result page that includes advertiser X's advertisement, and the user selects the advertisement, but the user does not take an action that constitutes a conversion. Assume further that the user subsequently submits a second search query for “Brand-X,” is presented with the advertiser X's advertisement, the user selects advertiser X's advertisement, and the user takes action that constitutes a conversion (e.g., the user purchases Brand-X tennis shoes). In this example, the keyword “Brand-X” will be credited with the conversion because the last advertisement selected prior to the conversion (“last selected advertisement”) was an advertisement that was presented in response to the “Brand-X” being matched.

Providing conversion credit to the keyword that caused the presentation of the last selected advertisement (“last selection credit”) prior to a conversion is a useful measure of advertisement performance, but this measure alone does not provide advertisers with data that facilitates analysis of a conversion cycle that includes user exposure to, and/or selection of, advertisements prior to the last selected advertisement. For example, last selection credit measures alone do not specify keywords that may have increased brand or product awareness through presentation of advertisements that were presented to, and/or selected by, users prior to selection of the last selected advertisement. However, these advertisements may have contributed significantly to the user subsequently taking action that constituted a conversion.

In the example above, the keyword “tennis” is not given any credit for the conversion, even though the advertisement that was presented in response to a search query matching the keyword “tennis” may have contributed to the user taking an action that constituted a conversion (e.g., making a purchase of Brand-X tennis shoes). For instance, upon user selection of the advertisement that was presented in response to the keyword “tennis” being matched, the user may have viewed Brand-X tennis shoes that were available from advertiser X. Based on the user's exposure to the Brand-X tennis shoes, the user may have subsequently submitted the search query “Brand-X” to find the tennis shoes from Brand-X. Similarly, the user's exposure to the advertisement that was targeted using the keyword “tennis,” irrespective of the user's selection of the advertisement, may have also contributed to the user subsequently taking action that constituted a conversion (e.g., purchasing a product from advertiser X). Analysis of user interactions, with an advertiser's advertisements (or other content), that occur prior to selection of the last selected advertisement can enhance an advertiser's ability to understand the advertiser's conversion cycle.

A conversion cycle is a period that begins when a user is presented an advertisement and ends at a time at which the user takes action that constitutes a conversion. A conversion cycle can be measured and/or constrained by time or actions and can span multiple user sessions. User sessions are sets of user interactions that are grouped together for analysis. Each user session includes data representing user interactions that were performed by a particular user and within a session window (i.e., a specified period). The session window can be, for example, a specified period of time (e.g., 1 hour, 1 day, or 1 month) or can be delineated using specified actions. For example, a user search session can include user search queries and subsequent actions that occur over a 1 hour period and/or occur prior to a session ending event (e.g., closing of a search browser).

Analysis of a conversion cycle can enhance an advertiser's ability to understand how its customers interact with advertisements over a conversion cycle. For example, if an advertiser determines that, on average, an amount of time from a user's first exposure to an advertisement to a conversion is 20 days, the advertiser can use this data to infer an amount of time that users spend researching alternative sources prior to converting (i.e., taking actions that constitute a conversion). Similarly, if an advertiser determines that many of the users that convert do so after presentation of advertisements that are targeted using a particular keyword, the advertiser may want to increase the amount of money that it spends on advertisements distributed using that keyword and/or increase the quality of advertisements that are targeted using that particular keyword.

Measures of user interactions that facilitate analysis of a conversion cycle are referred to as conversion path performance measures. A conversion path may include a set of user interactions by a particular user prior to and including a conversion by the particular user. Conversion path performance measures specify durations of conversion cycles, numbers of user interactions that occurred during conversion cycles, paths of user interactions that preceded a conversion, numbers of particular user interactions that occurred preceding conversions, as well as other measures of user interaction that occurred during conversion cycles, as described in more detail below.

The advertisement management system 110 includes a performance analysis apparatus 120 that determines conversion path performance measures that specify measures of user interactions with content items during conversion cycles. The performance analysis apparatus 120 tracks, for each advertiser, user interactions with advertisements that are provided by the advertiser, determines (i.e., computes) one or more conversion path performance measures, and provides data that cause presentation of a performance report specifying at least one of the conversion path performance measures. Using the performance report, the advertiser can analyze its conversion cycle, and learn how each of its keywords cause presentation of advertisements that facilitate conversions, irrespective of whether the keywords caused presentation of the last selected advertisement. In turn, the advertiser can adjust campaign parameters that control distribution of its advertisements based on the performance report.

Configuration options can be offered to reduce bias in performance reports. Without configuration options, some performance reports can be biased, such as towards short conversion paths. For example, a performance report can be biased towards short conversion paths if data used as a basis for the report includes a percentage of partial conversion paths which is higher than a threshold percentage. A partial conversion path is a conversion path in which some but not all user interaction data for a user is associated with a conversion. A partial conversion path can be included in a report if, for example, the report is generated using a reporting period which is less then the length of a typical conversion cycle for the advertiser who requested the report.

A reporting period determines the maximum length (in days) of a reported conversion cycle because additional data outside of the reporting period is not used to generate the report. A performance report can be based on a reporting period (i.e., lookback window), such that user interactions prior to the reporting period are not considered part of the conversion cycle when generating the report. Such a reporting period is referred to as a “lookback window”. For example, when generating a report with a lookback window of thirty days, available user interaction data representing user actions that occurred between July 1 and July 31 of a given year would be available for a conversion that occurred on July 31 of that year.

If a default lookback window (e.g., thirty days) is used, the performance report can be biased towards short conversion paths if the typical conversion cycle length for a product associated with the report is greater than the default lookback window. For instance, in the example above, a typical conversion cycle for “Brand-X” tennis shoes may be relatively short (e.g., thirty days) as compared to a conversion cycle for a more expensive product, such as a new car. A new car may have a much longer conversion cycle (e.g., ninety days).

Different advertisers or different products for an advertiser can have different associated conversion cycle lengths. For example, an advertiser that sells low cost (e.g., less than $100) products may specify a lookback window of 30 days, while an advertiser that sells more expensive products (e.g., at least $1000) may specify a lookback window of 90 days.

In some implementations, an advertiser 108 can specify a lookback window when requesting a performance report, such as by entering a number of days or by selecting a lookback window from a list of specific lookback windows (e.g., thirty days, sixty days, ninety days). Allowing an advertiser to configure the lookback window of their performance reports enables the advertiser to choose a lookback window that corresponds to conversion cycles of their products. Allowing lookback window configuration also enables advertisers to experiment with different lookback windows, which can result in the discovery of ways to improve conversion rates.

Other factors can contribute to reporting on partial conversion paths. For example, as mentioned above, user interaction data used as a basis for a report can be associated with unique identifiers that represent a user device with which the user interactions were performed. As described above, a unique identifier can be stored as a cookie. Cookies can be deleted from user devices, such as by a user deleting cookies, a browser deleting cookies (e.g., upon browser exit, based on a browser preference setting), or some other software (e.g., anti-spyware software) deleting cookies.

If cookies are deleted from a user device, a new cookie will be set on the user's device when the user visits a website (e.g., the search system 112). The new cookie may be used to store a new quasi-unique identifier, and thus subsequent user interaction data that occurs on the user device may be associated with a different identifier. Therefore, because each user identifier is considered to represent a different user, the user interaction data associated with the deleted cookies are identified as being associated with a different user than the user interaction data that is associated with the new cookies.

For instance, in the example above, assume that the user deletes cookies after the first search query for “tennis” is performed and that the second search query for “Brand-X” occurs after the cookies are deleted. In this example, performance measures computed based on the user interaction data for the user can show a bias. For example, a path length measure can be computed as one, rather than two, since the advertisement selection resulting from the first search query is not considered part of the same conversion cycle as the advertisement selection resulting from the second search query, since the two user interactions do not appear to have been performed by the same user.

To view a report which reduces bias caused from partial conversion paths, an advertiser can specify a lookback window for the report. As described above, the lookback window specifies that the user interaction data used to generate the report are user interaction data that are associated with unique identifiers that have initialization times that are prior to a specified period (e.g., thirty days, sixty days, ninety days) before the conversions. Thus, conversions for which user interaction data that are associated with unique identifiers having initialization times that are after the specified period are excluded from inclusion as a basis for the report. A unique identifier that has a recent initialization time indicates that the unique identifier may have been recently reinitialized on the user device that the unique identifier represents. Accordingly, user interaction data associated with the relatively new unique identifier may represent only a partial conversion path. Alternatively, conversions for which user interaction data that are associated with unique identifiers having initialization times that are after the specified period are included in the report. To reduce bias, any user interaction included in the conversion path that occurred after the specified period are removed from the conversion path prior to being included in the report.

Although FIG. 1 illustrates a single network 102, the environment 100 can include a plurality of communication networks and/or the plurality of communication networks can be configured in a plurality of ways (e.g., a plurality of interconnected local area networks (LAN), a plurality of interconnected wide area networks (WAN), a plurality of interconnected LANs and/or WANs, etc.). Similarly, although FIG. 1 illustrates the advertisement management system 110, the environment 100 can include any number of advertisement management systems. Other third party systems may analyze and display performance metrics managed by the advertisement management system 110 to the advertisers.

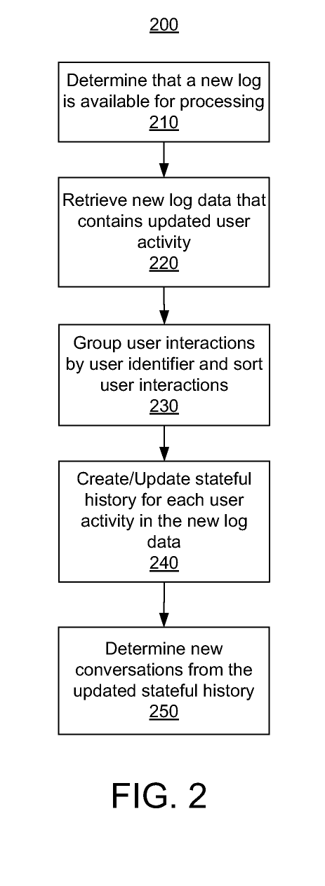

FIG. 2 is a flow diagram of a process for updating user interaction log data in accordance with an illustrative embodiment. The process 200 is a process that updates conversion paths and determines conversions based on the updated conversion paths of users.

The process 200 can be implemented on the advertisement management system 110, the performance analysis apparatus 120, or another computing device. In one implementation, the process 200 is encoded on a computer-readable medium that contains instructions that when executed by a computing device cause the computing device to perform operations of process 200.

As described above, log files 116 may contain user interaction data. A log file 116 may be combined with user interaction data from other logs from other servers, including those that implement the search system 112, prior to processing. Processing starts with the computing device that implements the process 200 determining that a new log is available for processing (210). For example, a notification can be sent to the computing device indicating that a new log is ready for processing, or the existence of a new log can indicate that the new log is ready for processing.

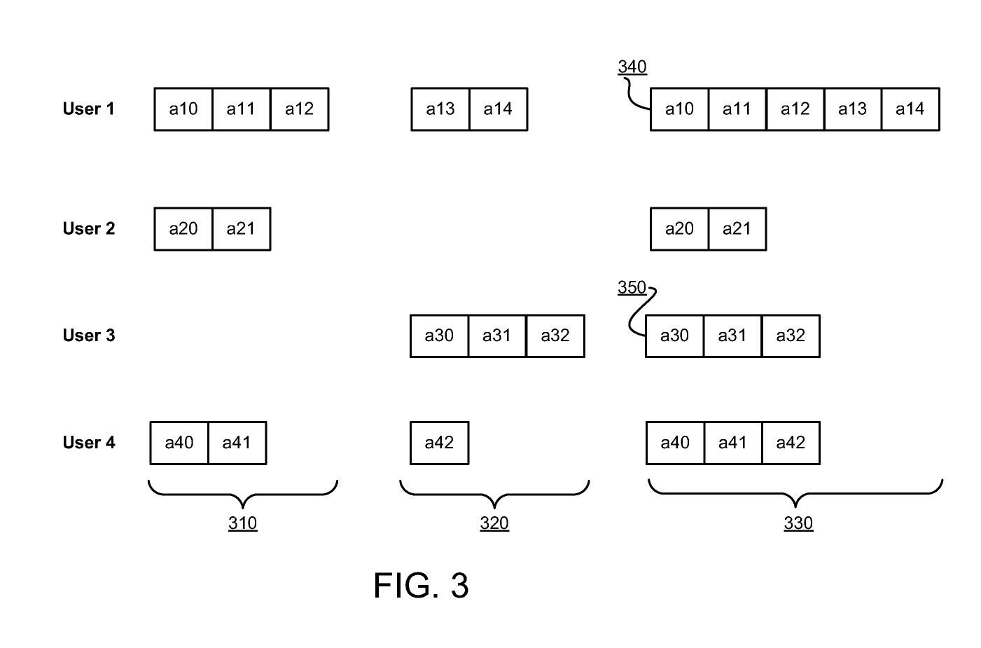

Next, the new log is retrieved (220). The new log file may be retrieved over the network 102. The stateful history for each user is updated based on the user activity indicated by the new log. The new log can contain information relating to user interactions for numerous users. The historical data 119 contains user interaction data from previously processed log files. The user interaction data contained within the historical data 119 can be stateful, in that the user interaction data can be grouped by user identifier and ordered chronologically. FIG. 3 is a block diagram that illustrates user interaction data being updated during a user interaction log data sorting process 200 in accordance with an illustrative embodiment. FIG. 3 illustrates four example user identifiers, although the historical data 119 and log files 116 can contain data associated with thousands or millions of different user identifiers. In one embodiment, previously stored user interaction data 310 are stored in the historical data 119. As illustrated, no user interaction data associated with user identifier 3 has been previously stored in the historical data store 119.

The new log can contain user interaction data for one or more user identifiers. The user interaction data can be grouped by user identifiers and then sorted chronologically (230). Column 320 illustrates grouped and sorted user interaction data. As illustrated, user identifier 2 does not include any new user interaction data, and user identifiers 1, 3, and 4 have updated user interaction data. For instance, the new log file includes user interaction data associated with user interactions a₁₃ and a₁₄ that are associated with user identifier 1. The grouped and sorted user interaction data can be merged with the user interaction data stored in the historical data 119 (240). If a user identifier previously existed in the historical data 119, the new user interaction data is added to the previous user interaction data. Otherwise, the new user interaction data is added with a new user identifier.

Column 330 illustrates the updated user interaction data for each of the user identifiers. Based on the updated user interaction data, any conversions that occurred in each of the updated paths of user interactions can be determined (250). User interaction paths are constrained to those user interactions that are related to particular advertisers 108. The conversion interactions of particular advertisers 108 are used to determine if a conversion has occurred. As an example, assume that user interactions a₁₃ and a₃₂ represent conversion interactions. Accordingly, conversion paths 340 and 350 are found. Once found, the conversion paths can be written to another portion of the historical data 119 or another data store for further analysis.

The advertisement management system 110 and/or the performance analysis apparatus 120 can be realized by instructions that upon execution cause one or more processing devices to carry out the processes and functions described above. Such instructions can comprise, for example, interpreted instructions, such as script instructions, executable code, or other instructions stored in a computer-readable medium. The advertisement management system 110 and/or the performance analysis apparatus 120 can be distributively implemented over a network, such as a server farm, or can be implemented in a single computer device.

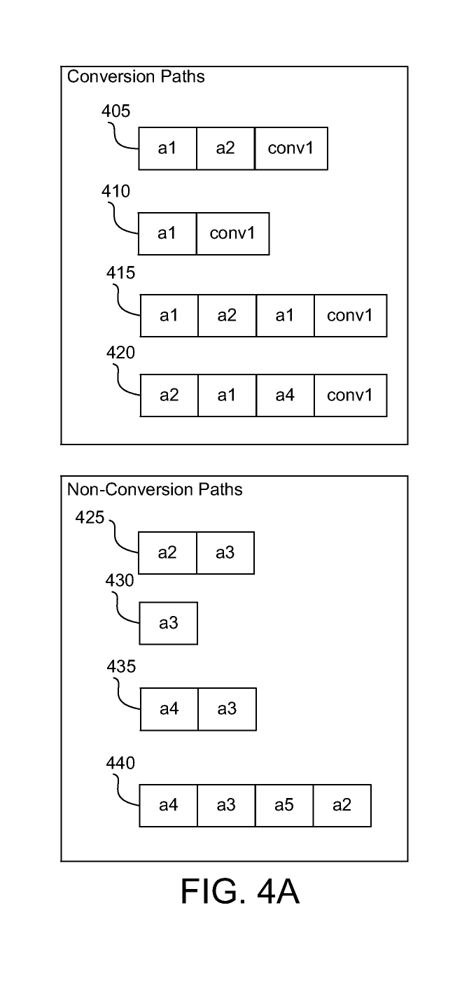

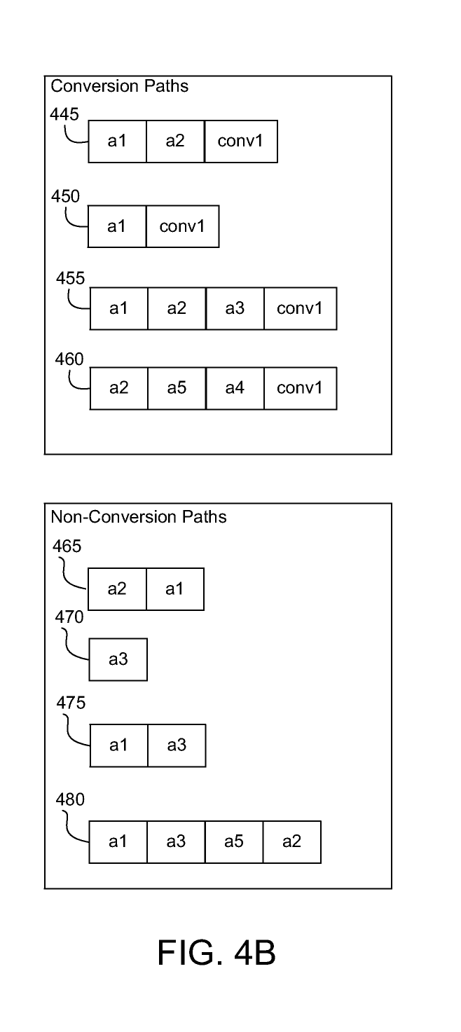

FIG. 4A is a block diagram that illustrates exemplary paths 405, 410, 415, 420, 425, 430, 435, and 440, in accordance with an illustrative embodiment. Conversion paths 405, 410, 415 and 420 end in a conversion 1 (e.g., a purchase of a product). As shown, the conversion path 405 includes user interactions a₁ and a₂, while the conversion path 410 includes user interaction a₁. The conversion path 415 is shown to include user interactions a₁, a₂, and a₁. Finally, the conversion path 420 includes user interactions a₂, a₁, and a₄. Accordingly, each of the four conversion paths 405, 410, 415 and 420 includes user interaction a₁. For example, the user interaction a₁ may represent an impression of a first advertisement.

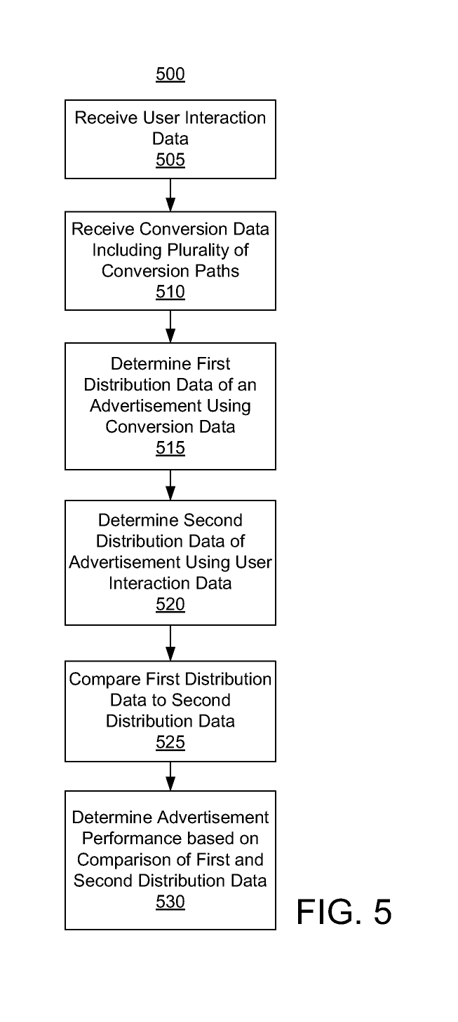

In addition, four non-conversion paths 425, 430, 435, and 440 are shown that do not end in a conversion. The non-conversion path 425 includes user interactions a₂ and a₃. The non-conversion path 430 includes user interaction a₃. The non-conversion path 435 includes user interactions a₄ and a₃, and the non-conversion path 440 includes user interactions a₄, a₃, a₅, and a₂. As illustrated, none of the non-conversion paths include user interaction a₁. Using a process 500 of FIG. 5, it may be determined whether the first advertisement helps in driving conversions. Assuming that the paths illustrated in FIG. 4A include the entire set of available user interaction data, it may be concluded that the first advertisement has a positive effect on the user's decision to convert based on comparison of distribution of the first advertisement's impressions in conversion paths with distribution in non-conversion paths (or alternatively with the first advertisement's overall distribution in user interaction data).

FIG. 4B is a block diagram that illustrates exemplary paths 445, 450, 455, 460, 465, 470, 475, and 480, in accordance with an illustrative embodiment. Conversion paths 445, 450, 455 and 460 end in a conversion 1 (e.g., a purchase of a product). The conversion path 445 includes user interactions a₁ and a₂, while the conversion path 450 includes user interaction a₁ The conversion path 455 is further shown to include user interactions a₁, a₂, and a₃. Finally, the conversion path 460 includes user interactions a₂, a₅, and a₄. Accordingly, the conversion paths 445, 450, and 455 include user interaction a₁.

In addition, four non-conversion paths 465, 470, 475, and 480 are shown that do not end in a conversion. The non-conversion path 465 includes user interactions a₂ and a₁. The non-conversion path 470 includes user interaction a₃. The non-conversion path 475 includes user interactions a₁ and a₃, and the non-conversion path 480 includes user interactions a₁, a₃, a₅, and a₂. Accordingly, the non-conversion paths 465, 475, and 480 include user interaction a₁. In one example, the user interaction a₁ may represent an impression of a second advertisement. Using a process 500 of FIG. 5, effectiveness of the second advertisement may be determined. The second advertisement appears frequently in conversion paths 445, 450, and 455 (i.e., 3 times), but equally frequently in non-conversion paths 465, 475, and 480. Accordingly, assuming that the paths illustrated in FIG. 4B include the entire set of available user interaction data, it may be concluded that the impressions of the second advertisement have no correlation with any conversions based on the comparison of distribution of the first advertisement's impressions in conversion paths with distribution in non-conversion paths (or alternatively with the first advertisement's overall distribution in user interaction data).

FIG. 5 is a flow diagram illustrating a process 500, employed by the advertisement management system 110 of FIG. 1 for determining advertisement performance based on distribution data comparison. The process 500 can be implemented on the advertisement management system 110, the performance analysis apparatus 120, or another computing device. In one implementation, the process 500 is encoded on a computer-readable medium that contains instructions that when executed by a computing device cause the computing device to perform operations of process 500.

At step 505, user interaction data is received from a data source. The data source can be the historical data 119, or a database maintained by the advertisement management system 110, or another system. The user interaction data is stored in a data source. The user interaction data may include time stamps that allows a processor to determine the sequence among a plurality of user interactions. The sequencing determination may be performed for any given advertiser or user. The user interaction history may be constructed by sequencing user interactions in time stamp order for any given advertiser and user combination.

The users may be identified in a data source by a cookie identifier while advertisers may be identified by an advertiser identifier. In some embodiments, the user interaction data may specify user interaction with content items and conversion items, which are user actions that satisfy one or more predetermined conversion criteria (e.g., user purchase, creation of new account, visit to a web site, etc.). User interaction data can represent all user interactions prior to a conversion. Content items can include advertisements that are presented with search results, text advertisements, etc. User interactions can include presentation of content items (i.e., impressions) and user selections (i.e., clicks) of content items. In some embodiments, the user interaction data may be limited to user interactions that occurred within a predetermined period of time (e.g., one week) before the conversion.

The received user interaction data may include user interactions with content items provided by a single advertiser. For example, the advertiser identifier along with the advertiser's user interaction data may be stored in a data store (e.g., historical data 117). In other embodiments, the received user interaction data may be associated with multiple advertisers. The received user interaction data may include all or a subset of all user interactions recorded in the data store for a particular advertiser including user interactions data that did not result in conversions. In some embodiments, the received user interaction data includes aggregated user interaction data by region, demographics, or other user interaction data attributes.

At step 510, conversion data, including conversion path data for a plurality of conversion paths, is received. The conversion data may correspond to one or more users, and one or more advertisement campaigns managed by one or more advertisers. Each conversion path includes user interaction data prior to and including a conversion event. Conversion path data may also include one or more performance measures (e.g., a path length measure) for each conversion path in the plurality of conversion paths.

At step 515, first distribution data of an advertisement in the received conversion data is determined. In some embodiments, the first distribution data may include distribution of the advertisement's impressions in the conversion paths in the conversion data. The first distribution data may include metrics such as advertisement frequency (e.g., how frequently the advertisement appears in the conversion paths for a single or for multiple users), advertisement reach (e.g., how many users viewed the advertisement), and other distribution metrics.

Second distribution data of an advertisement in the received user interaction data is determined (step 520). In some embodiments, the second distribution data may include distribution of the advertisement's impressions in the user interaction data. Similar to the first distribution data, the second distribution data may include metrics such as advertisement frequency, advertisement reach, etc. For example, the second distribution data may indicate how frequently the advertisement appears in the user interaction data associated with a single or with multiple users.

At step 525, the first distribution data is compared to the second distribution data. In some embodiments, the frequency metric data included in the first distribution data can be compared to the frequency metric data included in the second distribution data. In other embodiments, reach metric data may identify the number of individuals that were shown an advertisement. Other types of reach metric data may include exclusive reach metric data, such as, the number of individuals that were shown the advertisement from a particular web site. In other embodiments, the reach metric data included in the first distribution data can be compared to the reach metric data included in the second distribution data. In other embodiments, several metrics included in the distribution data are compared. Accordingly, global statistics (i.e., frequency metric data, reach metric data, and etc.) associated with the user interaction data are compared with conversion path data.

Based on the comparison of the first distribution data and the second distribution data, the advertisement performance is determined (step 530). For example, if the advertisement appears frequently in the conversion paths and equally frequently overall (i.e., in the user interaction data), then it can be determined that the advertisement is uncorrelated with any conversions. Similarly, if overall the advertisement appears more frequently than in conversion paths, then it may be suppressing conversion. In another example, if a fraction of converting users reached by an advertisement is greater than the overall fraction of users reached, it may be determined that the advertisement positively correlates with conversions.

A report may be generated indicating the relative performance of the advertisement using the results of the comparison of the distribution data performed in step 525 and the determination of the effect of the advertisement on conversions performed in step 530. The report may include data regarding correlation of the advertisement to conversions. Although the underlying reasons for any correlation of the advertisement to conversions can be advertisement performance, there are other possible reasons explaining the correlation such as the advertisement being shown disproportionately often on a website where the user performs the conversion. In this example, the report may indicate how often the advertisement is being shown on the website.

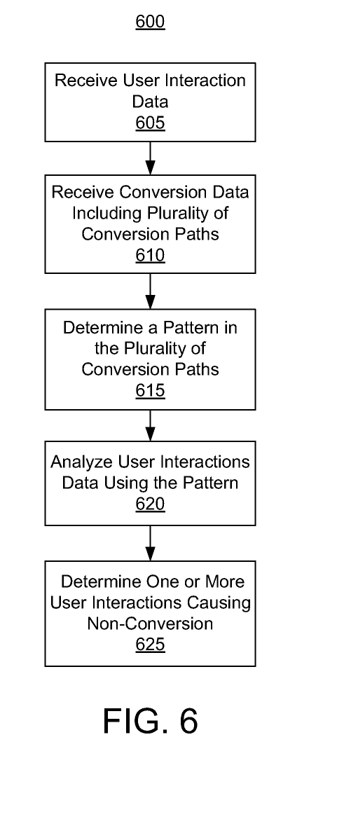

FIG. 6 is a flow diagram illustrating a process 600, employed by the advertisement management system 110 of FIG. 1 for identifying user interactions causing non-conversion using patterns derived from conversion data. The process 600 can be implemented on the advertisement management system 110, the performance analysis apparatus 120, or another computing device. In one implementation, the process 600 is encoded on a non-transitory computer-readable storage medium that contains instructions that when executed by a computing device cause the computing device to perform operations of process 600.

At step 605, user interaction data is received from a data source, which can be received in a similar manner as explained above with reference to step 505. At step 610, conversion data, including conversion path data for a plurality of conversion paths, is received, which can received in a similar manner as explained above with reference to step 510.

At step 615, a pattern in the plurality of conversion paths is determined. Known pattern recognition algorithms may be used, such as but not limited to, statistical analysis, predetermined Boolean expression matching. The pattern may include one or more user interactions typically found in conversion paths. For example, several conversion paths may contain a cluster of impressions of at least two advertisements out of advertisement 1, advertisement 2, and advertisement 3, as well as a click 4, all within a window of five minutes. In this example, click 4 frequently precedes the conversion, and would get attribution under the last-click attribution model. Accordingly, the determined pattern includes clusters of at least two out of advertisement 1, advertisement 2, and advertisement 3 as well as click 4 within windows of at most five minutes. One or more additional patterns may be determined using the conversion data.

At step 620, user interaction data is analyzed using the determined pattern. In some embodiments, the user interaction data is searched for the determined pattern, locating sequences of user interactions containing the pattern determined in step 615. The sequences of user interactions may include one or more user interactions in addition to the user interactions that form the pattern that may be used for determining when the user plausibly walked away and decided not to convert. At step 625, one or more user interactions causing or indicating non-conversion are determined using the analysis of the determined pattern. For example, if a user interaction follows the pattern in a sequence of user interactions located in the user interaction data, this user interaction may have caused the user to decide not to convert.

The user may decide to walk away and not convert because the advertisement negatively affected the user or alternatively because the product or website were unappealing to the user. Distinguishing between poor performing advertisements and advertisements that compelled the user to visit a website that did not result in a conversion can be done to optimize advertisement campaigns. For example, an advertisement may be considered successful if it compels the user to visit the advertiser's website (i.e., click leading to the website in question). In some embodiments, relevant clicks are obtained from the advertiser. In other embodiments, the relevant clicks are inferred from the conversion data (e.g., clicks that typically precede a conversion). In these embodiments, the relevant clicks inferred from the conversion data form patterns determined in step 615.

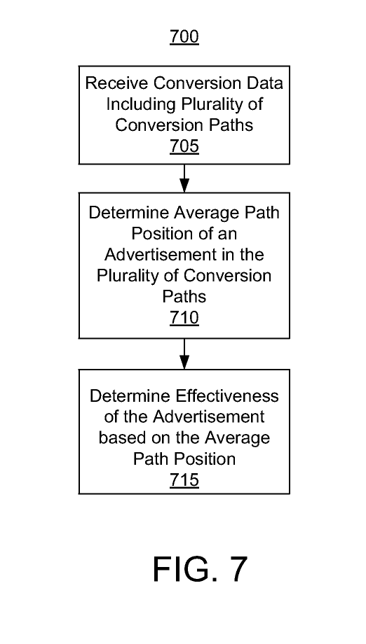

FIG. 7 is a flow diagram illustrating a process 700, employed by the advertisement management system 110 of FIG. 1 for facilitating the determination of an advertisement's effectiveness based on advertisement position in conversion paths. The process 700 can be implemented on the advertisement management system 110, the performance analysis apparatus 120, or another computing device. In one implementation, the process 700 is encoded on a computer-readable storage medium that contains instructions that when executed by a computing device cause the computing device to perform operations of process 700.

At step 705, conversion data, including conversion path data for a plurality of conversion paths, is received. The conversion data may correspond to one or more users and one or more advertisement campaigns managed by one or more advertisers. Each conversion path includes user interaction data prior to and including a conversion event. Conversion path data may also include one or more performance measures (e.g., a path length measure) for each conversion path in the plurality of conversion paths.

At step 710, average path position is determined for the advertisement using the received conversion data. In some embodiments, the position in a single conversion path is a single real number from a set of real numbers (e.g. 0.0 to 1.0 or 1 to 100 or the like) such that 0.0 indicates a position at the beginning of the path and 1.0 indicates a position at the end of the path. In other embodiments, the position in a single conversion path of a completely ineffective advertisement is likely to be distributed evenly from the beginning to the end, in a manner that does not correlate with any particular user or advertiser. The position in a single conversion path of an effective advertisement is likely to be distributed near the end of a conversion path or near the beginning of the conversion path. Accordingly, an effective advertisement may be closer to the beginning and the end than the middle of the conversion path. In other words, the distance between the middle of the conversion path and the position of an effective advertisement is greater than the distance between the beginning or the end of the conversion path and the position of the effective advertisement. However, the average position of ineffective advertisements can be skewed by the effective advertisements.

At step 715, effectiveness of the advertisement is determined based on the average path position. The ineffective advertisements may be expected to have an average position path that approximates 0.5 or about halfway between the beginning and the end. On the other hand, effective advertisement will have different path positions than the ineffective advertisements. For example, the effective advertisement may be closer to the conversion than ineffective advertisements. The effective advertisement may be expected to have an average position path that is approximately greater than 0.5. For example, an advertisement that is successful in driving conversion of one type (e.g., visit to a particular website) but ineffective for conversion of another type (e.g., product purchase) is expected to have differences between the distributions of the advertisement in paths leading up to conversions of two types. In other words, the distributions of an advertisement may be conversion type specific.

Relative performance of two advertisements within the same advertisement campaign may be analyzed using the process 700. For example, to assess relative effectiveness of advertisement 1 and advertisement 2 for driving conversion of type A, statistics of impression events for advertisements 1 and 2 in conversion paths with conversions of type A can be analyzed.

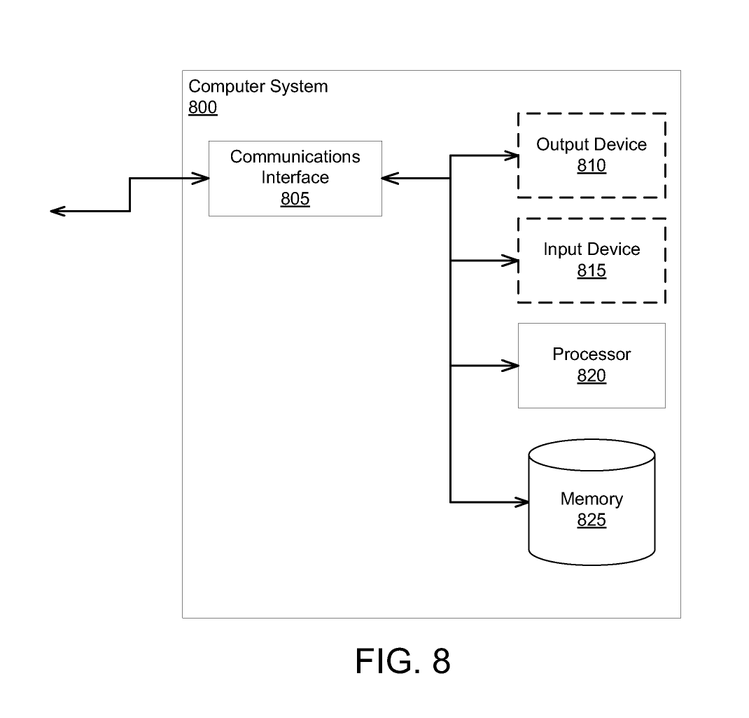

FIG. 8 shows the general architecture of an illustrative computer system 800 that may be employed to implement any of the computer systems discussed herein (including advertisement management system 110 and user devices 106) in accordance with some embodiments. The computer system 800 can be used to provide user interaction reports, process log files, implement an illustrative performance analysis apparatus 120, or implement an illustrative advertisement management system 110. The computer system 800 of FIG. 8 comprises one or more processor 820 communicatively coupled to memory (825), one or more communications interface 805, and optionally one or more output device 810 (e.g., one or more display units) and one or more input device (815).

In the computer system 800 of FIG. 8, the memory (825) may comprise any computer-readable storage media, and may store computer instructions (also referred to herein as “processor-executable instructions”) for implementing the various functionalities described herein for respective systems, as well as any data relating thereto, generated thereby, and/or received via the communications interface(s) or input device(s) (if present). Referring again to the environment 100 of FIG. 1, examples of the memory (825) include the historical data 119 of the advertisement management system. The processor 820 shown in FIG. 8 may be used to execute instructions stored in the memory (825) and, in so doing, also may read from or write to the memory various information processed and or generated pursuant to execution of the instructions.

The processor 820 of the computer system 800 shown in FIG. 8 also may be communicatively coupled to and/or control the communications interface 805 to transmit and/or receive various information pursuant to execution of instructions. In particular, the communications interface 805 may be coupled to a wired or wireless network, bus, or other communication means and may therefore allow the computer system 800 to transmit information to and/or receive information from other devices (e.g., other computer systems). While not shown explicitly in the advertisement management system of FIG. 1, one or more communications interfaces facilitate information flow between the various elements/subsystems of the environment 100. In some implementations, the communications interface(s) may be configured (e.g., via various hardware components and/or software components) to provide a website as an access portal to at least some aspects of the computer system 800. Examples of communications interface 805 include user interfaces (e.g., web pages) accessed by advertisers to track performance of advertisements.

The optional output device 810 of the computer system 800 shown in FIG. 8 may be provided, for example, to allow various information to be viewed or otherwise perceived in connection with execution of the instructions. The optional input device 815 may be provided, for example, to allow a user to make manual adjustments, make selections, enter data or various other information, and/or interact in any of a variety of manners with the processor during execution of the instructions. Additional information relating to a general computer system architecture that may be employed for various systems discussed herein is provided at the conclusion of this disclosure.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method of providing data related to an advertisement, the method comprising:
receiving user interaction data, wherein the user interaction data specifies user interaction with content items and conversion items, wherein a conversion item is a user action that satisfies a predetermined conversion criteria;
determining conversion path data from the user interaction data, the conversion path data for a plurality of conversion paths, wherein at least some conversion paths include a plurality of user interactions prior to a conversion event and a conversion event;
determining non-conversion path data from the user interaction data, the non-conversion path data for a plurality of non-conversion paths, wherein at least some non-conversion paths include a plurality of user interactions related to a user not converting;
determining, using a processor, a first distribution data that comprises a metric that is determined based on one or more events associated with the advertisement, wherein the one or more events occurred in the plurality of conversion paths;
determining, using the processor, a second distribution data that comprises a metric that is determined based on one or more events related to a user not converting, wherein the one or more events occurred in the non-conversion paths;
comparing the first distribution data to the second distribution data; and
determining performance data that indicates whether the advertisement had an affect on the conversion event, based on the comparison of the first distribution data and the second distribution data.

2. The method of claim 1, wherein the first distribution data includes a first frequency metric data and the second distribution data includes a second frequency metric data, the first frequency metric data and the second frequency metric data indicating average number of times users have viewed the advertisement.

3. The method of claim 1, wherein the first distribution data includes a first reach metric data and the second distribution data includes a second reach metric data, the first reach metric data and the second reach metric data indicating number of users that viewed the advertisement.

4. The method of claim 2, wherein the comparison of the first distribution data to the second distribution data includes comparing the first frequency metric data to the second frequency metric data.

5. The method of claim 3, wherein the comparison of the first distribution data to the second distribution data includes comparing the first reach metric data to the second reach metric data.

6. (canceled)

7. The method of claim 1, further comprising
providing performance data for the advertisement.

8. The method of claim 1, further comprising:
providing instructions to display the advertisement performance data.

9. The method of claim 1, wherein the conversion data corresponds to multiple users.

10. At least one non-transitory computer readable storage medium encoded with processor-executable instructions that, when executed by at least one processor, perform a method for providing data related to conversion paths, the method comprising:
receiving user interaction data, wherein the user interaction data specifies user interaction with content items and conversion items, wherein a conversion item is a user action that satisfies a predetermined conversion criteria;
determining conversion path data from the user interaction data, the conversion path data for a plurality of conversion paths, wherein at least some conversion paths include a plurality of user interactions prior to a conversion event and a conversion event;
determining non-conversion path data from the user interaction data, the non-conversion path data for a plurality of non-conversion paths, wherein at least some non-conversion paths include a plurality of user interactions related to a user not converting;
determining, using a processor, a first distribution data that comprises a metric that is determined based on one or more events associated with the advertisement, wherein the one or more events occurred in the plurality of conversion paths;
determining, using the processor, a second distribution data that comprises a metric that is determined based on one or more events related to a user not converting associated with the advertisement, wherein the one or more events occurred in the non-conversion paths;
comparing the first distribution data to the second distribution data; and
determining performance data that indicates whether the advertisement had an affect on the conversion event, based on the comparison of the first distribution data and the second distribution data.

11. The non-transitory computer readable storage medium of claim 10, wherein the first distribution data includes a first frequency metric data and the second distribution data includes a second frequency metric data, the first frequency metric data and the second frequency metric data indicating average number of times users have viewed the advertisement.

12. The non-transitory computer readable storage medium of claim 10, wherein the first distribution data includes a first reach metric data and the second distribution data includes a second reach metric data, the first reach metric data and the second reach metric data indicating number of users that viewed the advertisement.

13. The non-transitory computer readable storage medium of claim 11, wherein the comparison of the first distribution data to the second distribution data includes comparing the first frequency metric data to the second frequency metric data.

14. The non-transitory computer readable storage medium of claim 12, wherein the comparison of the first distribution data to the second distribution data includes comparing the first reach metric data to the second reach metric data.

15. (canceled)

16. The non-transitory computer readable storage medium of claim 10, the method further comprising:
providing performance data for the advertisements.

17. The non-transitory computer readable storage medium of claim 16, the method further comprising:
providing instructions to display the advertisement performance data.

18. The non-transitory computer readable storage medium of claim 10, wherein the conversion data corresponds to multiple users.

19. An apparatus for providing data related to conversion paths, the apparatus comprising:
at least one communications interface;
at least one memory to store processor-executable instructions; and
at least one processor communicatively coupled to the at least one communications interface and the at least one memory, wherein upon execution of the processor-executable instructions, the at least one processor:
receives user interaction data, wherein the user interaction data specifies user interaction with content items and conversion items, wherein a conversion item is a user action that satisfies a predetermined conversion criteria;
determines conversion path data from the user interaction data, the conversion path data for a plurality of conversion paths, wherein at least some conversion paths include a plurality of user interactions prior to a conversion event and a conversion event;
determines non-conversion path data from the user interaction data, the non-conversion path data for a plurality of non-conversion paths, wherein at least some non-conversion paths include a plurality of user interactions related to a user not converting;
determines, using a processor, a first distribution data that comprises a metric that is determined based on one or more events associated with the advertisement, wherein the one or more events occurred in the plurality of conversion paths;
determines, using the processor, a second distribution data that comprises a metric that is determined based on one or more events related to a user not converting associated with the advertisement, wherein the one or more events occurred in the non-conversion paths;
compares the first distribution data to the second distribution data; and
determines performance data that indicates whether the advertisement had an affect on the conversion event, based on the comparison of the first distribution data and the second distribution data.

20. The apparatus of claim 19
wherein the first distribution data includes a first frequency metric data and the second distribution data includes a second frequency metric data, the first frequency metric data and the second frequency metric data indicating average number of times users have viewed the advertisement;
wherein the comparison of the first distribution data to the second distribution data includes comparing the first frequency metric data to the second frequency metric data'
wherein the conversion data corresponds to multiple users.
